(19) United States
(12) Patent Application Publication
(10) Pub. No.: US 2013/0067632 A1
(43) Pub. Date: Mar. 21, 2013

(54) TEXTILE, AN ARTICLE OF CLOTHING AND A METHOD FOR PRODUCTION OF A TEXTILE

(71) Applicant: Luigi MARAMOTTI, Albinea (IT)

(72) Inventor: Luigi MARAMOTTI, Albinea (IT)

(73) Assignee: MAX MARA S.R.L., Reggio Emilia (IT)

(21) Appl. No.: 13/608,804

(22) Filed: Sep. 10, 2012

(30) Foreign Application Priority Data
Sep. 20, 2011 (IT) MO2011A000239

(51) Int. Cl. B32B 7/02; A41D 1/00; A41D 1/02; D06C 15/00

(52) U.S. Cl. 2/93; 428/221; 38/144; 2/69

(57) ABSTRACT

A multi-layer textile comprises a first layer of textile, a second layer of textile and an intermediate layer interposed between the first layer and the second layer, the intermediate layer being a layer of calendered textile.

The invention relates to a textile to be used for manufacturing articles of clothing, especially articles of clothing having windproof properties. The invention further concerns an article of clothing made using the above-mentioned textile, and a method for producing the textile.

The temperature perceived by a person in the open air depends not only on the temperature of the air that is effectively measurable at that moment, but also on other environmental conditions, such as the presence of wind or the degree of humidity. For example, when the degree of humidity rises, the sensation of heat perceived tends to increase, even if the temperature of the air is constant. Given a same air temperature, wind increases the sensation of cold.

In order to reduce the sensation of cold a person feels when exposed to the wind, windproof textiles have been developed which have the aim of preventing, as much as possible, the air from passing through the textile.

Windproof textiles of known type generally have a multi-layer structure and comprise at least a membrane coupled, for example by lamination, spreading or another coupling technique, to a textile layer. The membrane acts as a barrier for limiting or preventing passage of the air. The membrane is usually made of a polymer material, for example polytetrafluoroethylene.

Windproof textiles of known type, while having good wind-blocking capacities, exhibit however some drawbacks.

In particular, the membrane that acts as a barrier to the air is a polymer film, which is not especially soft to the touch. Using a jargon typical of the textile field, this concept can be expressed by saying that windproof textiles of known type normally generate a “crackly and papery feeling to the touch”. In other words, touching the windproof textile incorporating the membrane gives a stiff feeling, almost as if one were handling a sheet of paper. This detracts from the user's comfort when wearing an article of clothing made by using the windproof textile of known type. The wearability of the clothes made by using the windproof textile of known type is not excellent as the textile constituting them is rather stiff.

An object of the invention is to improve the textiles of known type, especially the textiles having windproof properties.

A further object is to provide a textile and an article of clothing having good barrier properties to air, and at the same time being soft and light to the touch.

A further object is to provide a textile that has good barrier properties to air and provides clothes that are highly wearable.

A further object is to provide a method which enables obtaining a textile and an article of clothing having the above-mentioned properties.

In a first aspect of the invention, there is provided a multi-layer textile, comprising a first layer of textile, a second layer of textile and an intermediate layer interposed between the first layer and the second layer, wherein the intermediate layer is a layer of calendered textile.

In a second aspect of the invention, there is provided an article of clothing comprising an inner layer suitable for being positioned closer to a user's body, an outer layer suitable for being positioned further from the user's body and an intermediate layer interposed between the outer layer and the inner layer, wherein the intermediate layer is a layer of calendered textile.

In a third aspect of the invention, there is provided a method comprising the step of providing a first layer of textile, a second layer of textile and an intermediate layer of textile interposed between the first layer and the second layer, the method further comprising at least one step of calendering the intermediate layer.

Calendering allows the fibres forming the textile of the intermediate layer to be crushed. These fibres, which originally had a substantially circular transverse section, thus take on a crushed transverse section, for example oval or elliptical. This enables reducing the dimensions of the interstices defined between the warp and weft of the textile forming the intermediate layer and thus substantially limiting the passage of air through the intermediate layer. Thus a textile can be obtained having good windproof properties.

At the same time, as the calendering process does not completely close up the interstices defined between the warp and weft of the intermediate layer, the multi-layer textile has good transpiration properties.

Further, the windproof properties are mainly obtained owing to the intermediate layer which, differently to the barrier layers of the prior art, is made of a textile material, i.e. obtained starting from textile fibres. The intermediate layer is consequently softer and lighter than the membranes of the prior art. This makes the multi-layer textile of the invention particularly pleasant to the touch, and also increases comfort and wearability of the clothes made using the textile material.

The invention can be better understood and carried out with reference to the accompanying drawings, which illustrate an exemplary and non-limiting embodiment thereof, in which:

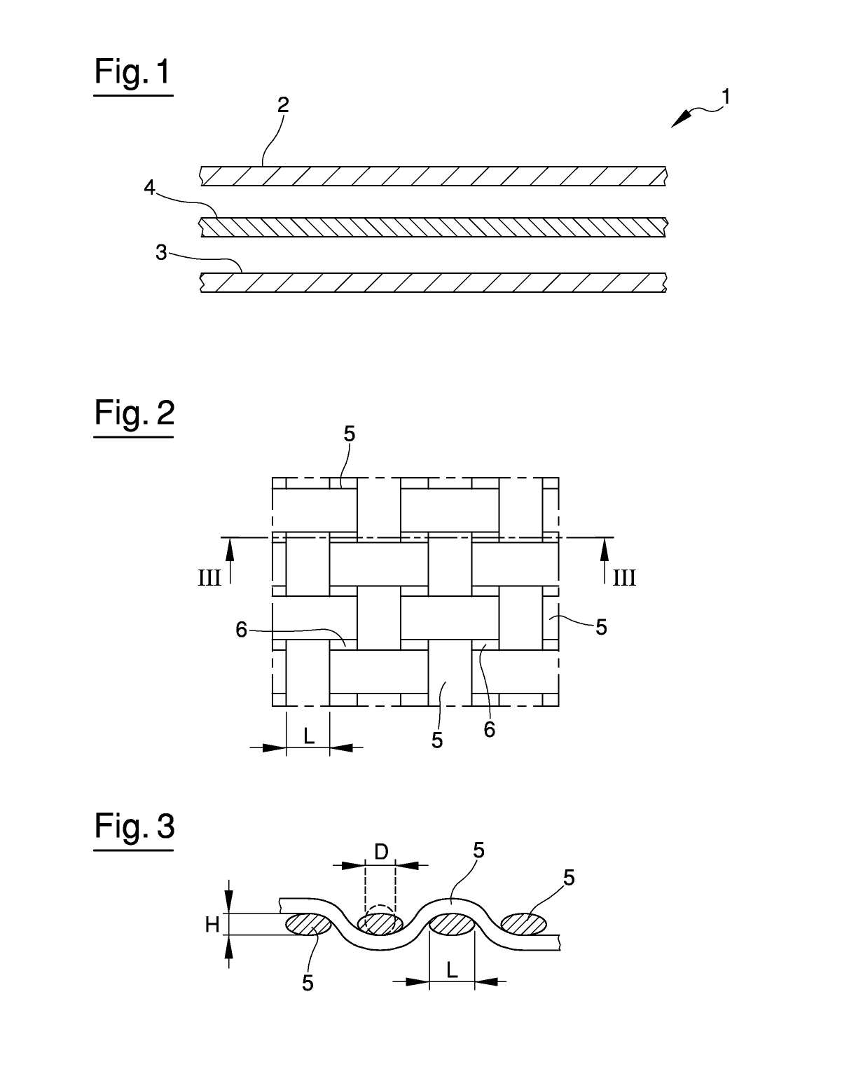

FIG. 1 is a schematic and enlarged cross-section of a multi-layer textile;

FIG. 2 is a schematic and enlarged view from above showing a portion of an intermediate layer of the multi-layer textile of FIG. 1;

FIG. 3 is a schematic section, taken along plane III-III of FIG. 2;

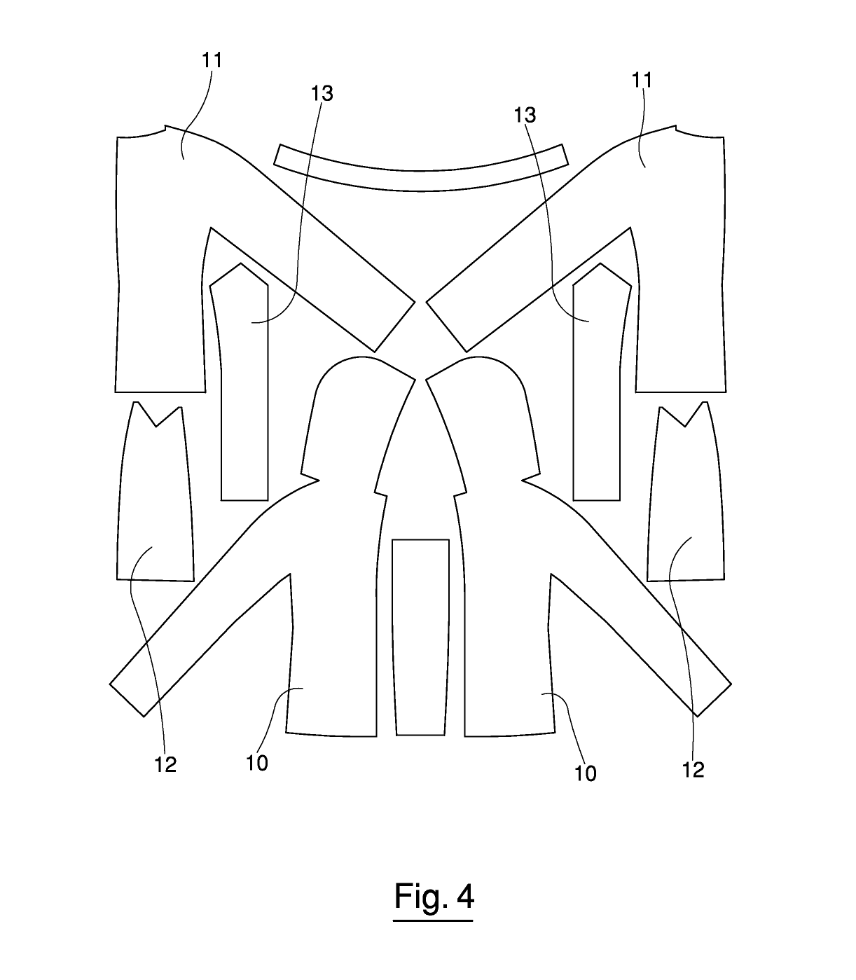

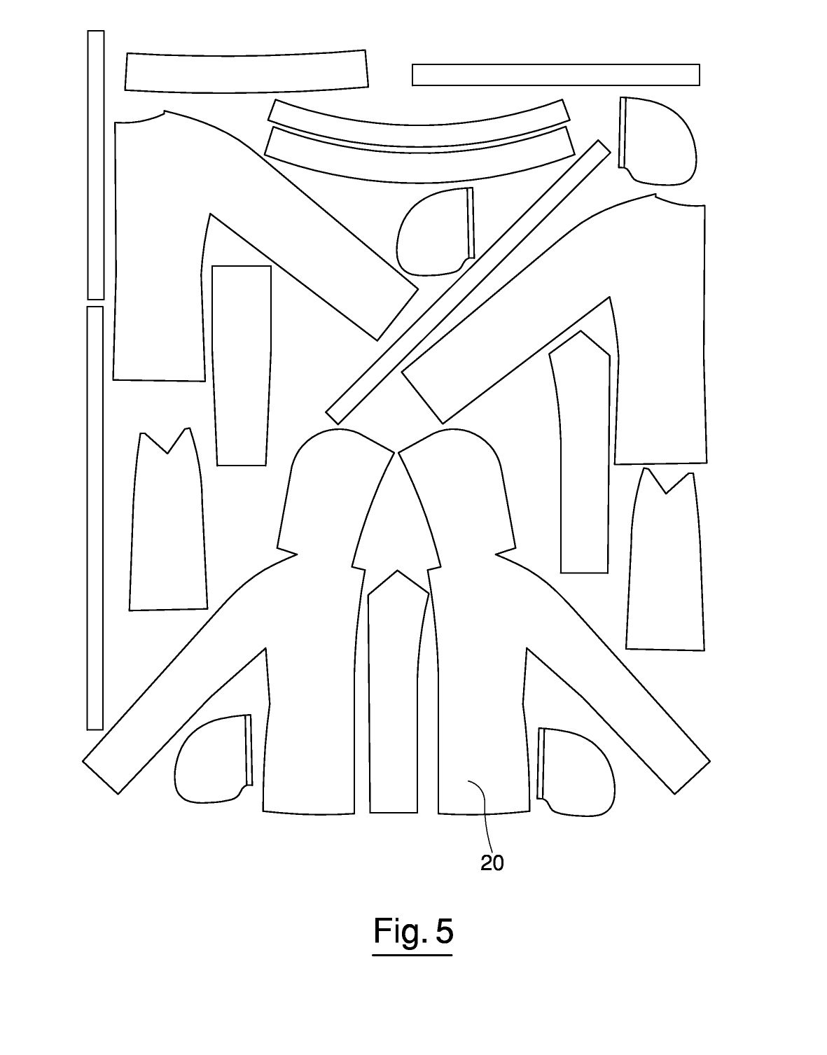

FIG. 4 is a view showing the components of an interlayer of a jacket;

FIG. 5 is a view showing the components of an inner layer of the jacket of FIG. 4;

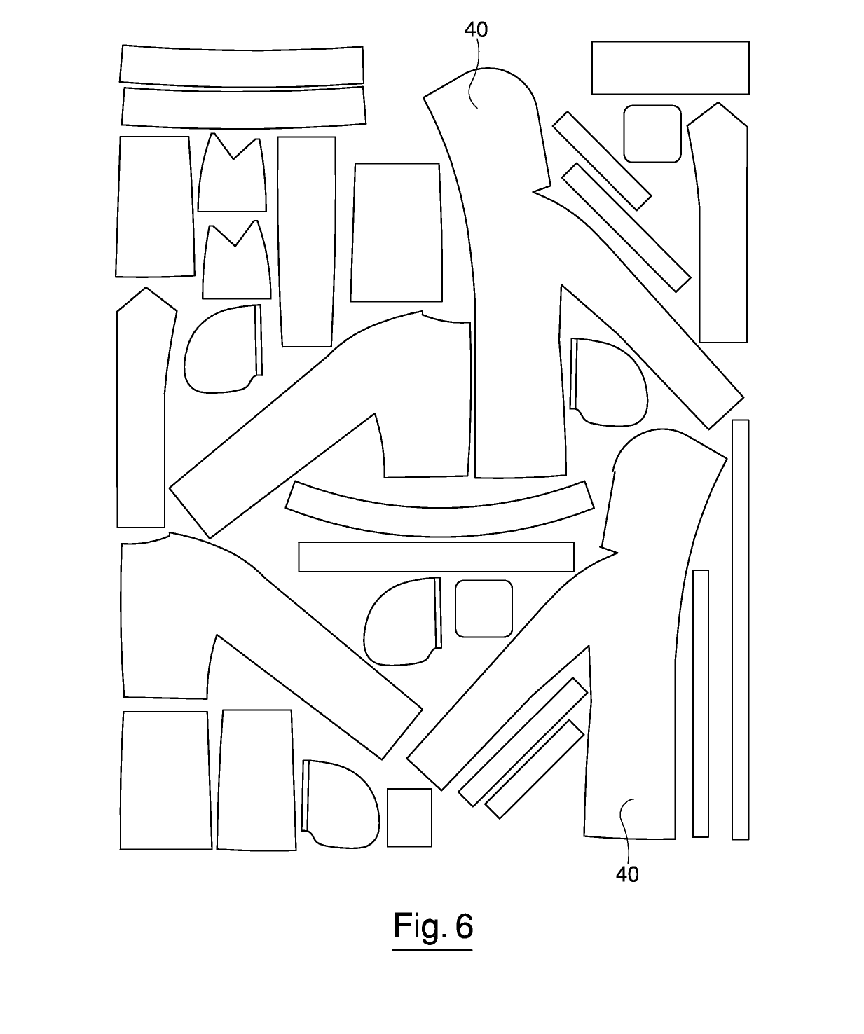

FIG. 6 is a view showing the components of an outer layer of the jacket of FIG. 4;

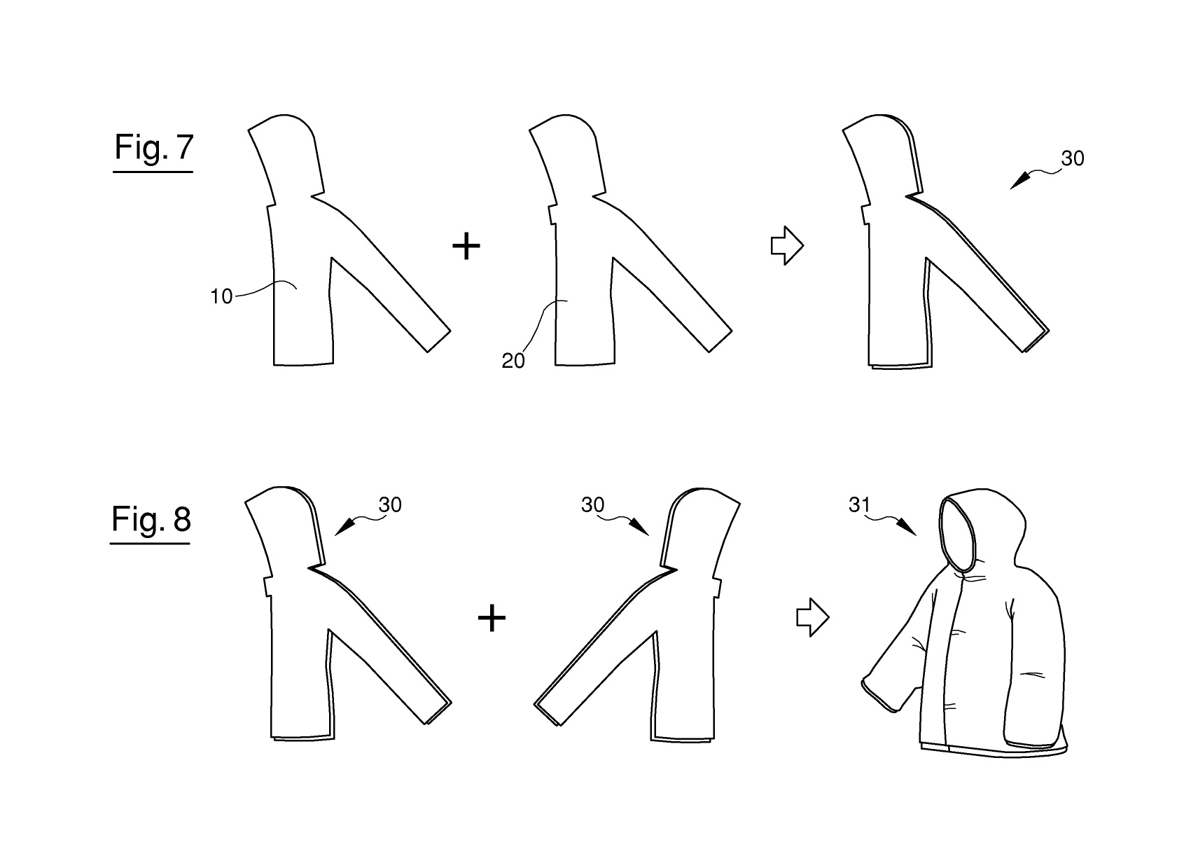

FIGS. 7 to 10 are schematic drawings showing some steps of a method for obtaining a jacket.

FIG. 1 schematically shows a multi-layer textile 1, comprising a first layer 2 and a second layer 3, between which an intermediate layer 4 is interposed. As will be more fully explained herein below, the intermediate layer 4 gives the multi-layer textile air-barrier properties, which makes the multi-layer textile 1 suitable to be used for making windproof articles of clothing.

The intermediate layer 4 is made of a textile, that is with a material comprising textile fibres forming a plurality of threads 5, shown in FIGS. 2 and 3, arranged so as to define a weft and a warp.

The first layer 2 and the second layer 3 are also made with respective textiles.

For example, the first layer 2 can be made with a textile that is polyester-based, polyamide-based or a combination of polyester/polyamide. The first layer 2 can be treated so as to exhibit special technical properties, for example rainproof properties obtained via a treatment making the textile water-repellent.

The second layer 3 can be made of a textile based on polyester, for example polyester micro-taffeta.

The intermediate layer 4 can be made of a textile based on polyester or polyamide. In an embodiment, the intermediate layer 4 can be made with a 40 g/m² 22-denier nylon textile.

For the first layer 2, the second layer 3 and the intermediate layer 4, different materials to the ones mentioned above can be used.

Before forming the multi-layer textile 1, the textile destined to form the intermediate layer 4 is subjected to a calendering operation. This operation is carried out by passing the textile destined to form the intermediate layer 4 between two calendering rollers, one of which is heated. The calendering rollers apply a predetermined pressure on the textile.

The temperature of the heated calendering roller may be between 150° C. and 200° C., in particular between 160° C. and 180° C. The calendering rollers can be adjusted so as to apply a pressure of between 190 and 230 bar, in particular 210 bar, on the textile destined to form the intermediate layer 4. The textile destined to form the intermediate layer 4 can move at a velocity of between 7 and 10 metres per minute, in particular between 8 and 9 metres per minute, when it is passed through the calendering rolls.

The calendering operation enables crushing the threads 5 forming the textile destined to form the intermediate layer 4. Thus the threads 5, which initially had a substantially circular cross-section, are deformed so that their cross-section becomes substantially oval, as shown in FIG. 3. The deformed cross-section of each thread 5 has a minor transverse dimension H and a major transverse dimension L. The major transverse dimension L is measured parallel to the plane defined by the textile destined to form the intermediate layer 4. The major transverse dimension L is greater than the diameter D of the initial circular cross-section, said initial circular cross-section being indicated by a dashed line in FIG. 3.

By crushing the thread 5 during the calendering operation, it is therefore possible to reduce the size of the interstices 6, shown in FIG. 2, defined between the weft and warp of the textile destined to form the intermediate layer 4. This means that passage of air through the intermediate layer 4 can be prevented, which gives the multi-layer textile 1 windproof properties.

At the same time, since the textile that will form the intermediate layer 4 is not a continuous film, but the interstices 6—albeit smaller—remain even after the calendering operation, the textile has good breathability properties.

Standardized laboratory testing has verified that the windproof properties improve if the calendering operation applied to the textile destined to form the intermediate layer 4 is repeated more than once. This is due to the fact that the greater the number of times the textile is made to pass between the calendering rollers, the more the threads 5 making up the textile are crushed and the smaller the dimensions of the interstices 6.

However, the size of the interstices 6 can not be excessively reduced so as not to unacceptably affect the breathability properties of the textile destined to form the intermediate layer 4.

Tests have also shown that the best results are obtained by subjecting the textile destined to form the intermediate layer 4 to three calendering operations. In other words, the best results are obtained if the textile that will form the intermediate layer 4 is passed three times between the calendering rollers. The multi-layer textile 1 comprising a thus-treated intermediate layer 4 has been tested for air permeability and resistance to water vapour. The air permeability tests, carried out according to the UNI-EN ISO 9237:1996 standards, gave a mean air permeability value of less than 5 millimetres per second, enabling the textile to be given a class 3 classification according to the UNI-EN 342:2004/AC:2008 standard, i.e. the best class, which includes the highest-quality technical windproof clothing. The tests for resistance to water vapour, carried out according to the UNI-EN 31092:1996 standard, gave a mean resistance to water vapour value of less than 12 m²·Pa/W, which classifies the textile as having good breathability.

The three calendering operations therefore enable the threads 5 to be crushed in a way that ensures the best compromise between the increase of resistance to air passage of and the decrease in breathability.

In the portion of multi-layer textile 1 of FIG. 1, the intermediate layer 4 is shown as detached from the first layer 2 and the second layer 3. Contrary to what happens in laminated multi-layer textiles in the prior art, where the layers making up the laminated textile are joined to one another over the entire surface of a layer facing the adjacent layer, the multi-layer textile 1 has areas where the intermediate layer 4 does not adhere permanently to the first layer 2 and the second layer 3. In other words, there exists at least a central region of the multi-layer textile 1 in which the intermediate layer 4 is detached from the first layer 2 and the second layer 3. This further improves the feeling of softness and lightness that the user perceives when touching the multi-layer textile 1, compared to a case where the three layers forming the multi-layer textile 1 adhere to one another along the entire extension of the respective facing surfaces.

Furthermore, between the first layer 2 and the intermediate layer 4, as well as between the second layer 3 and the intermediate layer 4, two chambers or pockets of air may at least temporarily be formed that improve the thermal insulation provided by the article of clothing made with the multi-layer textile 1. In particular, the air chamber formed between the intermediate layer 4 and the layer—selected from between the first layer 2 and the second layer 3—positioned closer to the body of the user limits the dispersion of heat from the body of the user towards the external environment. Instead, the air chamber formed between the intermediate layer 4 and the layer—selected from between the second layer 3 and the first layer 2—exposed to the external environment, restricts the amount of cold air that can reach contact with the user's body.

The multi-layer textile 1, owing to the low air permeability and good breathability that distinguish it, can be used to make articles of clothing with windproof properties, particularly jackets, as will be described below with reference to FIGS. 4 to 10.

The textile of the intermediate layer 4, after being calendered, is cut so as to obtain a plurality of pieces, each of which is intended to form a part of the jacket. In particular, the pieces obtained by cutting the textile of the intermediate layer 4 are shaped in such a way as to form an interlayer of the jacket when they are sewn together.

FIG. 4 shows an example of how it is possible to shape the pieces that enable the interlayer of the jacket to be formed, starting from the textile of the intermediate layer 4. These pieces include two rear halves 10, two front halves 11, two side panels 12, two sleeve parts 13, and other minor strips.

The textile of the first layer 2 is cut so as to obtain a plurality of shaped pieces that can be subsequently sewn together to obtain a layer of the jacket, for example an inner layer, i.e. a layer destined to come into contact with the user's body. FIG. 5 shows an example of how the pieces obtained from the first layer 2 can be shaped. In the example shown, from the first layer 2 a number of pieces are formed that is higher than the number of pieces obtained from the intermediate layer 4, since the inner layer of the jacket comprises a plurality of components, for example pockets and belts, which are not provided or required in the interlayer formed by the intermediate layer 4.

The textile of the second layer 3 is also cut so as to obtain a plurality of shaped pieces that can subsequently be sewn together to obtain a layer of the jacket. In particular, the pieces obtained from the second layer 3 may be shaped so as to obtain an outer layer, i.e. a layer destined to be positioned further away from the user's body with respect to the inner layer and the interlayer. FIG. 6 shows an example of a possible arrangement of the pieces cut from the textile of the second layer 3. In this case too, the number of pieces into which the textile of the second layer 3 has been cut is much greater than the number of pieces obtained from the textile of the intermediate layer 4, since the outer layer of the jacket includes many components not provided or not necessary in the interlayer.

The jacket obtainable starting from the pieces shown in FIGS. 4 to 6 is reversible, i.e. designed and sewn in such a way that it can be worn with either the first layer 2 in contact with the user's body and the second layer 3 facing the external environment, or with the second layer 3 in contact with the user's body and the first layer 2 directed towards the external environment. The surface of the intermediate layer 4 which, as a result of contact with the heated calendering roll, has become more glossy, is directed toward the first layer 2.

Of course, the multi-layer textile 1 can also be used for making non-reversible jackets. Further, the pieces cut from the first layer 2, the second layer 3 and the intermediate layer 4 may also have shapes, sizes or different arrangements from those shown in FIGS. 4 to 6.

The pieces obtained from the textile which forms the intermediate layer 4 are associated to the corresponding pieces cut from the textile that forms the first layer 2. This step is schematically illustrated in FIG. 7, which shows a rear half 10 formed with the textile of the intermediate layer 4 and a rear half 20 formed with the textile of the first layer 2, which are positioned close to one another such as to define a bilayer component 30.

In this way a plurality of bilayer components 30 is obtained, each bilayer component 30 being formed by a piece of textile of the intermediate layer 4 and by the corresponding piece of textile of the first layer 2. The bilayer components 30 are joined to each other to obtain a first preliminary jacket or first jacket precursor 31. This step is shown schematically in FIG. 8, which shows only two bilayer components 30, corresponding to a right rear half and a left rear half. However, it is clear that the step of joining the bilayer components 30 involves all the bilayer components 30 made with the textile pieces of the first layer 2 and the intermediate layer 4. In particular, the bilayer components 30 are joined by sewing each bilayer component 30 to adjacent bilayer components 30 close to the respective peripheral edges. In this way, it is possible to join to one another, at the same time, not only the bilayer components 30, but also the pieces of textile of the first layer 2 and the intermediate layer 4 which form each bilayer component 30.

In an alternative embodiment, a first joining step can be performed in which the textile pieces of the first layer 2 and the intermediate layer 4 are joined to one another at respective edge regions to form the individual bilayer components 30. Subsequently, in a second joining step, the bilayer components 30 are sewn to one another to obtain the first jacket precursor 31.

In any case, the first jacket precursor 31 has the same shape as the finished jacket, i.e. it includes the sleeves, the rear or back part, the front parts and possibly the hood, and is formed by a plurality of bilayer components 30 joined to one another near the respective peripheral edges. The textiles that form each component bilayer 30 are, however, detached from each other, i.e. not joined to one another, in the central areas defined internally of the peripheral edges.

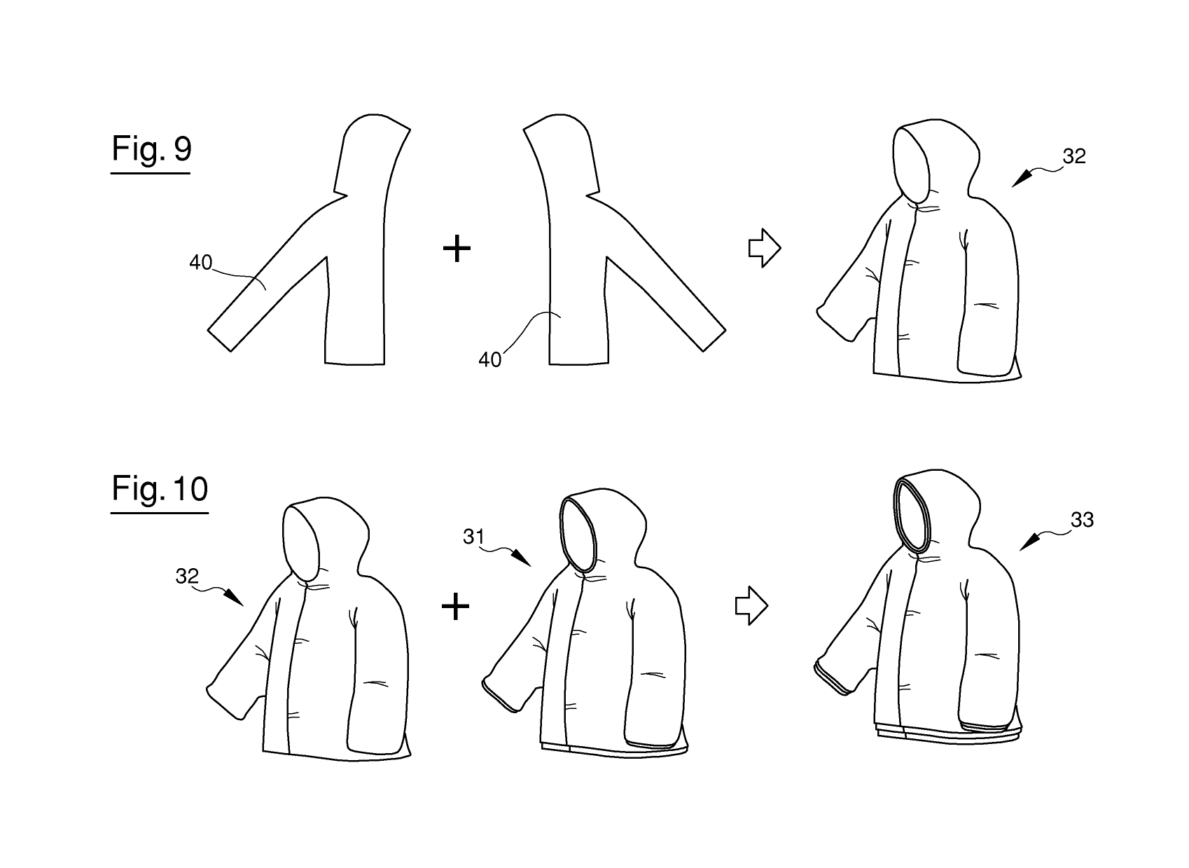

To obtain the finished jacket, a step is also provided in which the pieces cut from the textile of the second layer 3 are joined to one another, for example by means of seams arranged near the edge zones of adjacent pieces, to obtain a second preliminary jacket or second jacket precursor 32. This step is shown schematically in FIG. 9, in which two rear halves 40 are shown which are joined to one another, the rear halves 40 being formed with the textile of the second layer 3. It is however clear that this joining step involves all the pieces cut from the textile of the second layer 3.

The second jacket precursor 32 has therefore the same shape as the finished jacket, but is formed by a single layer of textile, i.e. the second layer 3.

Finally, the first jacket precursor 31 is joined to the second jacket precursor 32, for example by seams provided at selected zones. In one embodiment, the first jacket precursor 31 and the second jacket precursor 32 are joined to one another at least along zones of the external edge of the jacket, such as the hem of the article of clothing, the hood perimeter and the free edges of the front halves. Joining points can also be included below the armpits and on the neckline.

Thus a jacket 33 is obtained having a three-layer structure, as shown schematically in FIG. 10.

Owing to the calendered intermediate layer 4, the jacket 33 has good windproof properties and at the same time is lighter, softer and more pleasant to the touch compared to traditional windproof jackets, in which the air barrier properties are provided by films or polymeric membranes having a non-negligible stiffness.

The feeling of lightness and softness is increased because the layers that form the multi-layer textile 1 making the jacket 33 are joined together only at predetermined seams, and are detached in one or more regions interposed between the seams joining them. This enables obtaining articles of clothing with better wearability and comfort for the user in comparison with traditional multi-layer structures in which the layers are joined to one another along the entire extent of their facing surfaces. These structures are inevitably stiff and fit less comfortably to the contours of the body.

In addition, in the zones where the intermediate layer 4 is detached from the textile that forms the inner layer of the jacket 33, pockets or air chambers may form which limit the heat loss from the user's body towards the external environment. Likewise, in areas where the intermediate layer 4 is detached from the textile that forms the outer layer, pockets or air chambers may form which make it more difficult for the outside cold air to come into contact with the user's body. This can improve the thermal insulation properties of the jacket 33.

Finally, by providing a first jacket precursor having a bilayer structure which is subsequently joined to a second jacket precursor having a monolayer structure, it is possible to maintain good qualities of softness and lightness of the textile without over-complicating the sewing operations, as would happen instead if three monolayer jacket precursors were to be joined together.

Although FIGS. 4 to 10 are referred to a jacket, it is understood that the multi-layer textile 1 can also be used to create articles of clothing different from jackets, for example trousers.

1. A multi-layer textile, comprising a first layer of textile, a second layer of textile and an intermediate layer interposed between the first layer and the second layer, wherein the intermediate layer is a layer of calendered textile.

2. A multi-layer textile according to claim 1, wherein the intermediate layer has been calendered three times.

3. A multi-layer textile according to claim 1, wherein the intermediate layer is formed by a plurality of threads having a substantially oval cross-section, the threads being arranged in such a way that a larger dimension of said substantially oval cross-section is in a plane defined by the intermediate layer.

4. A multi-layer textile according to claim 1, wherein the intermediate layer is joined to the first layer and to the second layer by sewing.

5. A multi-layer textile according to claim 1, wherein the intermediate layer is detached from the first layer and from the second layer at least in a central region thereof.

6. A multi-layer textile according to claim 1, wherein the first layer, the second layer and the intermediate layer are made of respective textiles selected from a group comprising: polyester, polyamide or combinations of polyester and polyamide.

7. A multi-layer textile according to claim 1, wherein the first layer has anti-drip properties.

8. A multi-layer textile according to claim 1, wherein the second layer is in a micro-taffeta form.

9. An article of clothing made with a multi-layer textile, the multi-layer textile comprising a first layer of textile, a second layer of textile and an intermediate layer interposed between the first layer and the second layer, wherein the intermediate layer is a layer of calendered textile and the intermediate layer forms an inter-layer of the article of clothing.

10. An article of clothing according to claim 9, conformed as a reversible article of clothing, wherein the first layer can be used alternatively as an inner layer or an outer layer of the article of clothing and the second layer can be used alternatively as an outer layer or an inner layer of the article of clothing.

11. An article of clothing according to claim 9, conformed as a jacket.

12. An article of clothing according to claim 11, comprising a first preliminary jacket formed by the first layer and the intermediate layer, a second preliminary jacket formed by the second layer, the first preliminary jacket and the second preliminary jacket being joined to one another along outer edge zones of the jacket.

13. An article of clothing according to claim 12, wherein the first preliminary jacket comprises a plurality of bi-layer components formed by pieces of the first layer and pieces of the intermediate layer, said pieces being joined along edge zones of each bi-layer component, such that the first layer is separated from the intermediate layer in a central region of each bi-layer component.

14. An article of clothing according to claim 9, wherein at least one air chamber is defined between the intermediate layer and a layer destined to come into contact with a user's body and selected from between the first layer and the second layer, at least one further air chamber being defined between the intermediate layer and a layer destined to face an external environment and selected from the second layer and the first layer, said at least one air chamber limiting heat dispersion from the user's body, said at least one further air chamber limiting cold air penetration from outside.

15. A method comprising the step of providing a first layer of textile, a second layer of textile and an intermediate layer of textile interposed between the first layer and the second layer, the method further comprising at least one step of calendering the intermediate layer.

16. A method according to claim 15, wherein the intermediate layer is calendered three times.

17. A method according to claim 15, wherein the intermediate layer is formed by a plurality of threads which, during said at least one step of calendering, are crushed such as to increase a transverse dimension of a cross-section thereof.

18. A method according to claim 15, wherein, during said at least one step of calendering, the intermediate layer, advancing at a speed between 7 and 10 metres per minute, is subjected to a temperature between 150 and 200° C., and to a pressure between 190 and 230 bar.
